(19) United States
(12) Patent Application Publication
(10) Pub. No.: US 2025/0310270 A1
(43) Pub. Date: Oct. 2, 2025

(54) VEHICLE CONTROL SYSTEM

(71) Applicant: HONDA MOTOR CO., LTD., Tokyo (JP)

(72) Inventors: Kazuki Fukui, Tokyo (JP); Takahiro Moro, Tokyo (JP)

(21) Appl. No.: 19/006,593

(22) Filed: Dec. 31, 2024

(30) Foreign Application Priority Data
Mar. 28, 2024 (JP) 2024-054124

(51) Int. Cl. H04L 47/36; H04L 45/745

(52) U.S. Cl. CPC H04L 47/36; H04L 45/745

(57) ABSTRACT

A vehicle control system includes: a transfer unit that is connected to a first control device group connected to a first communication network and a second control device group connected to a second communication network different from the first communication network, and that transfers at least one communication packet including at least one message between communication networks including the first communication network and the second communication network; and a processing unit that processes a communication packet containing more than a predetermined number of messages, the communication packet being included in at least one communication packet received by the transfer unit from the communication networks, wherein the transfer unit transfers a communication packet containing the predetermined number or less of the message or messages, and the processing unit performs processing to enable a communication packet, containing more than the predetermined number of the messages, to be transferred by the transfer unit.

### INCORPORATION BY REFERENCE

The present application claims priority under 35 U.S.C. § 119 to Japanese Patent Application No. 2024-054124 filed on Mar. 28, 2024. The content of the application is incorporated herein by reference in its entirety.

### BACKGROUND OF THE INVENTION

### Field of the Invention

The present invention relates to a vehicle control system.

### Description of the Related Art

In recent years, research and development has been conducted to improve the safety of control in vehicles.

International Patent Publication No. WO 2021/002010 describes an unauthorized frame detection device that detects the transmission of unauthorized frames in an in-vehicle network system that employs service-oriented communication and prevents the setup of unauthorized communication. In this device, the transmission of an unauthorized frame is detected from the relationship of the ports to which the server and the client physically connect.

In the technology related to the safety of vehicle control, the challenge is to achieve both high defensive quality against attack on vehicle control and high responsiveness of vehicle control.

In order to solve the above problems, the present application aims to quickly detect unauthorized communication from an attacker and defend a vehicle control system against unauthorized communication while maintaining high responsiveness of vehicle control. Furthermore, this will contribute to further improving traffic safety and developing a sustainable transportation system.

### SUMMARY OF THE INVENTION

An aspect of the present invention is a vehicle control system mounted on a vehicle, including: a transfer unit that is connected to a first control device group connected to a first communication network and a second control device group connected to a second communication network different from the first communication network, and that transfers at least one communication packet including at least one message between communication networks including the first communication network and the second communication network; and a processing unit that processes a communication packet containing more than a predetermined number of messages, the communication packet being included in at least one communication packet received by the transfer unit from the communication networks, wherein the transfer unit transfers a communication packet containing the predetermined number or less of the message or messages, and the processing unit performs processing to enable a communication packet, containing more than the predetermined number of the messages, to be transferred by the transfer unit. Advantageous Effect of Invention

According to the aspect of the present invention, a configuration for transferring a communication packet between different communication networks makes it possible to defend the vehicle control system against unauthorized communication from an attacker while maintaining high responsiveness of vehicle control.

### BRIEF DESCRIPTION OF THE DRAWINGS

FIG. 1 is a diagram showing a configuration of a vehicle control system according to one embodiment of the present invention;

FIG. 2 is a diagram showing a configuration of a transfer determination unit;

FIG. 3 is a diagram showing an example of a search condition used by the transfer determination unit;

FIG. 4 is a diagram showing a configuration example of an Ethernet frame used in SOME/IP communication;

FIG. 5 is a diagram showing a configuration example of an Ethernet frame used in SOME/IP communication; and

FIG. 6 is a flowchart showing operation of a processing unit.

### DETAILED DESCRIPTION OF THE INVENTION

Embodiments of the present invention will be described below with reference to the drawings.

### [1. Configuration of Vehicle Control System]

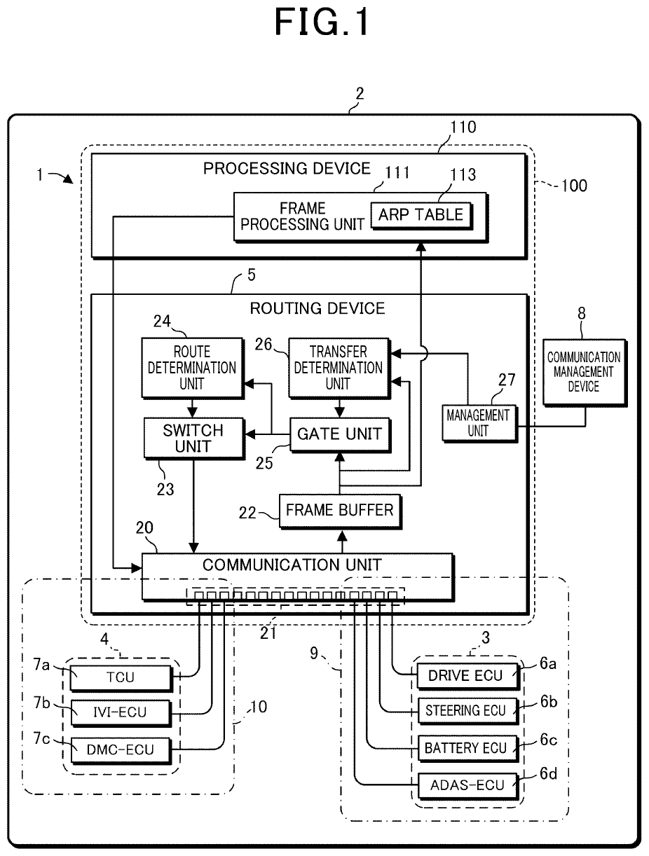

FIG. 1 is a diagram showing a configuration of a vehicle control system 1 according to one embodiment of the present invention. The vehicle control system 1 is mounted on a vehicle 2 and controls operation of the vehicle 2. The vehicle 2 may be any vehicle driven by an internal combustion engine and/or a motor. In this embodiment, the vehicle 2 is, for example, an electric vehicle driven by a drive motor powered by an on-board battery (neither of which is shown).

The vehicle control system 1 includes a first control device group 3, a second control device group 4, a vehicle control unit 100, and a communication management device 8. In this embodiment, the first control device group 3 does not include a control device that communicates with the outside of the vehicle 2, but includes a control device that performs control within the vehicle 2. For example, the first control device group 3 includes a control device that performs control related to the motion control of the vehicle 2. In this embodiment, the first control device group 3 includes a drive ECU (Electronic Control Unit) 6a, a steering ECU 6b, a battery ECU 6c, and an ADAS (Advanced Driver-Assistance System)-ECU 6d as control devices that perform control related to the motion control of the vehicle 2.

The drive ECU 6a controls the operation of the drive motor that drives the vehicle 2. The steering ECU 6b controls the operation of steering, deceleration, acceleration, and others of the vehicle 2 based on the handling operation of the steering wheel, brake, accelerator, and others of the vehicle 2. The battery ECU 6c detects the remaining charge and others of the on-board battery and controls the power supply operation to the drive motor. The ADAS-ECU 6d controls the driver assistance operation such as cruising operation and lane keeping operation of the vehicle 2. Hereinafter, the drive ECU 6a, the steering ECU 6b, the battery ECU 6c, and the ADAS-ECU 6d included in the first control device group 3 will be collectively referred to as an ECU 6.

The second control device group 4 includes control devices that communicate with the outside of the vehicle 2. For example, the second control device group 4 includes control devices other than the control devices that perform control related to the motion control of the vehicle 2. In this embodiment, the second control device group 4 includes a TCU (Telematics Control Unit) 7a and an IVI (In-Vehicle Infotainment)-ECU 7b as control devices that communicate with the outside of the vehicle 2. The TCU 7a is a wireless communication device for communicating with devices outside the vehicle 2 directly or indirectly via an external communication network. The IVI-ECU 7b receives radio waves of radio and television broadcast, and/or GPS signals, and displays images and videos to the occupants of the vehicle 2 on an in-vehicle display device, speaker, etc., (neither of which is shown), and/or provides information such as route guidance.

The second control device group 4 also includes a DMC (Driver Monitoring Camera)-ECU 7c that controls the operation of a DMC (not shown) installed in the passenger compartment of the vehicle 2. Hereinafter, the TCU 7a, the IVI-ECU 7b, and the DMC-ECU 7c included in the second control device group 4 will be collectively referred to as an ECU 7.

In this embodiment, the first control device group 3 and the second control device group 4 include respectively four and three control devices, but each control device group only needs to have at least one control device.

Each of the ECU 6 and the ECU 7 is equipped with a computer and performs predetermined control operation and communication with other in-vehicle devices.

In this embodiment, the ECU 6 and the ECU 7 perform SOME/IP communication (Service Oriented MiddleWarE Over IP), which is defined in the AUTOSAR (AUTomotive Open System Architecture), using IP packets conforming to the UDP (User Datagram Protocol) communication standard, in accordance with the Ethernet (registered trademark) communication standard.

The ECU 6 of the first control device group 3 and the ECU 7 of the second control device group 4 are connected to a routing device 5 and respectively constitute a first communication network 9 and a second communication network 10. The first communication network 9 and the second communication network 10 are, for example, VLAN (Virtual Local Area Networks).

The vehicle control unit 100 has the routing device 5 and a processing device 110.

The routing device 5 transfers communication between communication networks including the first communication network 9 and the second communication network 10, and transfers communication within each communication network, enabling communication between ECUs including the ECU 6 and ECU 7. The routing device 5 can be implemented, for example, as an L3 switch. The routing device 5 is an example of a transfer unit of the present disclosure.

In this embodiment, in particular, the routing device 5 checks an IP packet of communication between the ECU 6 and the ECU 7, and discards an IP packet used for unauthorized communication to prevent the execution of unauthorized communication.

The routing device 5 is connected to the communication management device 8. The communication management device 8 sets the check conditions for IP packets for the routing device 5. The routing device 5 may be built into the communication management device 8.

The processing device 110 performs processing to reconstruct packets for communication transmitted from the second control device group 4 to the first control device group 3, as described below. The processing device 110 has a function to hook communication from the second control device group 4 to the first control device group 3, and executes processing for communication that satisfies predetermined conditions. The processing device 110 is an example of a processing unit of the present disclosure.

The vehicle control unit 100 may include the communication management device 8. The processing device 110 and the communication management device 8 may be implemented in the same hardware, and the communication management device 8 may include the routing device 5.

### [2. Outline of Ethernet (Registered Trademark) Frames in SOME/IP Communication]

Here, an outline of Ethernet frame in SOME/IP communication handled by the vehicle control system 1 will be described.

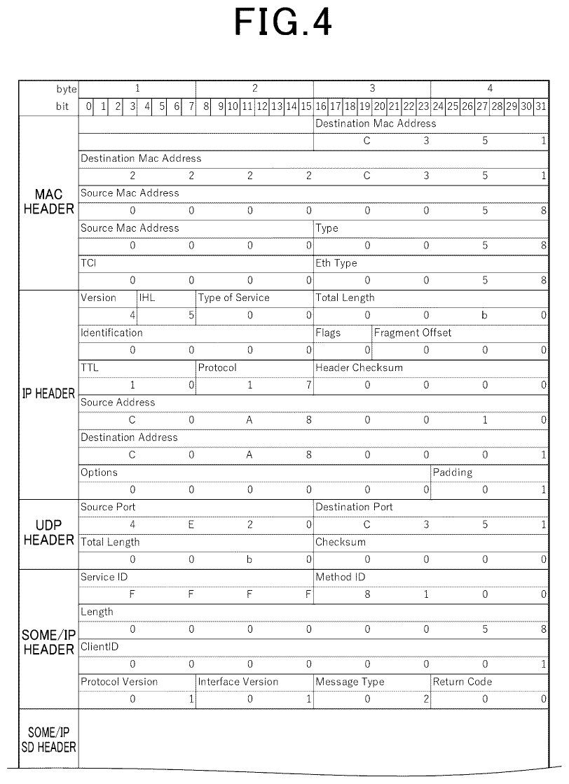

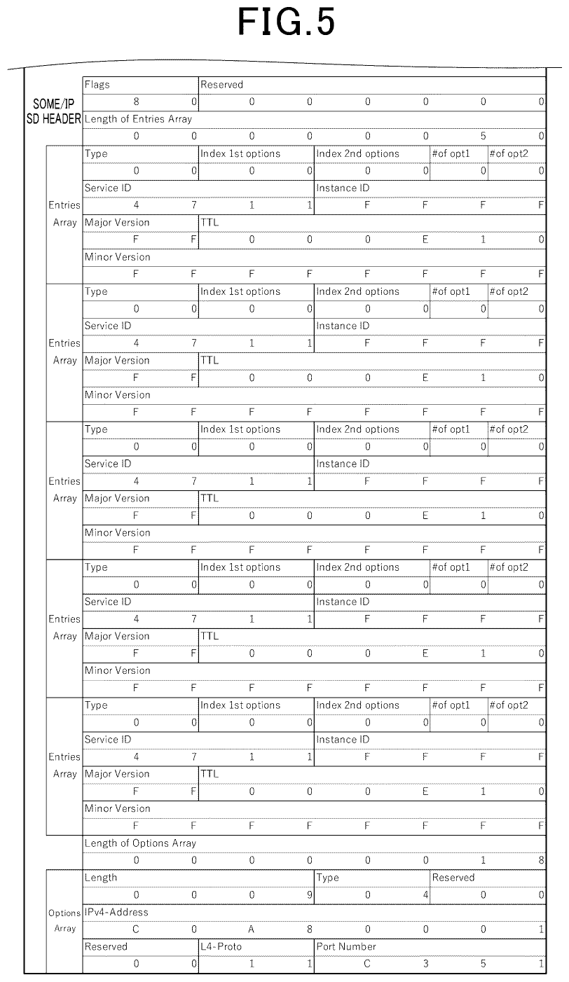

FIGS. 4 and 5 show an Ethernet frame in performing SOME-IP-SD communication as an example of an Ethernet frame in SOME/IP communication, and one Ethernet frame is divided into FIGS. 4 and 5. The Ethernet frame shown in the figure is configured of an 18-byte MAC header and an IP packet (after an IP header) that contains a message (SOME/IP message) defined in SOME/IP communication.

The MAC header contains the following fields: Destination MAC Address, Source MAC Address, TCI, Type, and EthType. The Destination MAC Address field indicates the MAC address of the destination device, and the Source MAC Address field indicates the MAC address of the source device. The TCI field is an identification value of the VLAN, and indicates either the first communication network 9 or the second communication network 10. The Type field and Eth Type field are well-known fields, so their explanation will be omitted.

The IP packet may contain an IP header, a UDP header, and a SOME/IP header and SOME/IP-SD header, which are part of the SOME/IP message. The SOME/IP-SD header contains an Entries Array and an Options Array.

The IP header, the UDP header, the SOME/IP header, and the SOME/IP-SD header are well-known. In the following, in order to simplify the explanation to facilitate understanding, the fields that configure these headers will not be explained one by one, and only the parts related to the characteristic operation of the vehicle control system 1 according to this embodiment will be explained to make them sure.

The SourceAddress field of the IP header and SourcePort of the UDP header respectively indicate the IP address (source address) and communication port number (source port number) of the source device of this communication packet. The DestinationAddress field of the IP header and DestinationPort of the UTP header respectively indicate the IP address (destination address) and communication port number (destination port number), of the destination device (receiving device) of this communication packet. Here, the IP address is a local IP address in the LAN (including VLAN) to which the corresponding device is connected.

The source device can specify the IP address of a specific device in the DestinationAddress field and transmit the communication packet in unicast, and the source device can also specify a predefined IP address (multicast address) indicating a plurality of destination devices in a predetermined area and transmit the communication packet in multicast to the plurality of destination devices.

In the case of SOME/IP-SD communication, the ServiceID field and the MethodID field of the SOME/IP header respectively store O×FFFF and 0×8100, as dedicated values indicating that the communication is SOME/IP-SD communication.

The SOME/IP-SD header contains an EntriesArray field.

The SOME/IP communication standard defined by AUTOSAR allows various messages, such as FindService and OfferService messages, for a plurality of different services to be communicated using a single IP packet. In other words, the Entries Array in the SOME/IP-SD header is permitted to contain a plurality of 16-byte units of information (specifically, information from the Type field to the Instance ID), each of which represents a single message. Hereinafter, the above 16-byte unit of information portion per service will be referred to as a service entry. In other words, the number of service entries contained in the Entries Array is optional, and the Entries Array is variable length information.

The Length of Entries Array field of the SOME/IP-SD header indicates the length of the bit string in which the service entry is stored, and the length is 0×10 (i.e., 16 bytes) when there is one service entry. In the example shown in FIGS. 4 and 5, five service entries are contained, so the value of the Length of Entries Array field is 0×50 (i.e., 80 bytes). In this example, the SOME/IP-SD header contains five Entries Arrays corresponding to the five service entries. The Length of Entries Array field can be said to indicate the number of service entries, and is an example of the message count field of the present disclosure.

### [3. Routing Device]

The configuration and operation of the routing device 5 will be described.

With reference to FIG. 1, the routing device 5 includes, as functional elements (or functional units), a communication unit 20, a frame buffer 22, a switch unit 23, a route determination unit 24, a gate unit 25, a transfer determination unit 26, and a management unit 27.

These functional elements may be implemented, for example, by semiconductor devices included in the routing device 5. Such semiconductor devices may include a processor (computer), a dedicated LSI such as an ASIC, an FPGA, and/or a memory.

The communication unit 20 is a transceiver that communicates in accordance with the Ethernet standard. For example, the communication unit 20 may be configured of a so-called PHY (PHYsical layer) circuit chip. The communication unit 20 includes a plurality of input/output ports 21 (referring to a plurality of rectangles within the dashed rectangle denoted by reference numeral 21 in FIG. 1), and communicates with the ECU 6 and the ECU 7 connected to these input/output ports 21.

The frame buffer 22 is a memory for temporarily storing Ethernet frames received by the communication unit 20 from the ECU 6 and the ECU 7. The frame buffer 22 sequentially outputs the temporarily stored Ethernet frames to the gate unit 25, described below.

The switch unit 23 performs communication transfer between the input/output ports 21 of the communication unit 20 to which the ECU 6 or the ECU 7 are connected, according to information from the route determination unit 24, in accordance with the conventional technique. In this embodiment, the switch unit 23 particularly performs communication transfer for Ethernet frames input to the switch unit 23 via the gate unit 25, in the Ethernet frames received at any of the input/output ports 21 of the communication unit 20 and temporarily stored in the frame buffer 22.

For each of Ethernet frames sent from the frame buffer 22 via the gate unit 25, the route determination unit 24 refers to a routing table (not shown) in accordance with the conventional technique to determine the input/output port 21 that is the transfer destination of the IP packet contained in that Ethernet frame. The route determination unit 24 notifies the switch unit 23 of information specifying the input/output port 21 that should be the transfer destination for each IP packet.

The gate unit 25 outputs the Ethernet frames, which are sent from the frame buffer 22, to the switch unit 23 and the route determination unit 24, or discards it, according to instructions from the transfer determination unit 26.

The management unit 27 acquires search conditions (described below) to be used by the transfer determination unit 26 from the communication management device 8, for example, in the start of the routing device 5, to set them in the transfer determination unit 26.

The transfer determination unit 26 determines whether or not to permit transfer between communication networks for each of the communication packets (in this embodiment, IP packets, and the same applies below) contained in the Ethernet frame received by the routing device 5. In other words, the transfer determination unit 26 checks the Ethernet frames containing IP packets to be transmitted and received between the ECU 6 and the ECU 7. The transfer determination unit 26 instructs the gate unit 25 to discard Ethernet frames that contain invalid IP packets. As a result, IP packets that the transfer determination unit 26 determines to be invalid IP packets are discarded without being transferred.

In this embodiment, the transfer determination unit 26 is configured, for example, of a TCAM (Ternary Content Addressable Memory). With a plurality of specific bit strings (arrays of bit values) specified as search conditions, the TCAM uses hardware processing to search the bit strings input to the TCAM (input bit strings) at high speed for bit strings that match the bit strings specified as the search conditions. When the TCAM finds a bit string that matches a bit string indicated by any of the search conditions, in the input bit strings, it outputs a search result that includes: information that identifies the search condition having led to the match (for example, the identification number of the search condition); and information about the found bit string.

TCAM can use three values, two values of “1” and “0” plus “X (Don't Care)”, particularly for the value of each bit in the bit string that is the search condition. For example, if “001XX000” is specified as the search condition, it is determined that the search returns a hit if the input bit string contains any of “00100000”, “00110000”, “00101000”, and “00111000”.

TCAM includes a memory (hereinafter referred to as a condition storage memory) for storing the bit string of the search condition. The storage area of the condition storage memory is usually divided into partitions of a predetermined size (for example, a predetermined number of bytes). Here, these partitions are referred to as TCAM entries. Search conditions are set in TCAM entry units (for example, two entries for one condition, or three entries for one condition, etc.).

For example, in this embodiment, the size of a TCAM entry in the transfer determination unit 26 is 48 bytes, and a storage area for 512 TCAM entries is reserved in the condition storage memory. However, these numerical values are merely examples, and the size and the reserved number of TCAM entries in the condition storage memory can be designed freely based on the size and the number of search conditions required, within the size of the storage area that can be reserved for the condition storage memory.

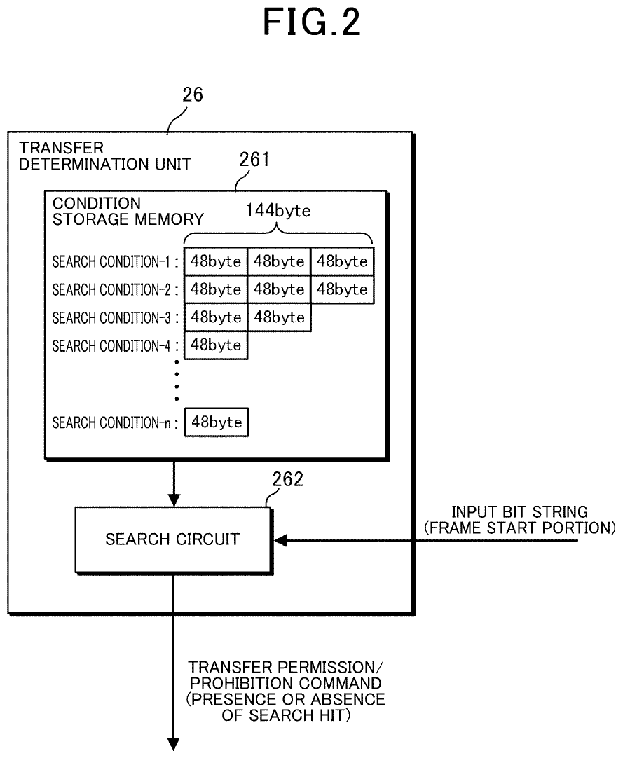

FIG. 2 is a functional block diagram showing operation of the transfer determination unit 26. The transfer determination unit 26 includes a condition storage memory 261 that stores search conditions, and a search circuit 262. The search circuit 262 acquires the start portion of each received Ethernet frame from the frame buffer 22, as an input bit string. The search circuit 262 searches the input bit string for a bit pattern indicated by each search condition stored in the condition storage memory 261. The above-mentioned start portion is, for example, 144 bytes containing 106 bytes from the start of the Ethernet frame to the end of the first SOME/IP-SD header.

Then, the search circuit 262 outputs the search result of whether or not a bit pattern indicated by any of the search conditions is found in the input bit string (i.e., the presence or absence of a search hit), as a transfer permission command or a transfer prohibition command for that Ethernet frame. In other words, the search result of the search circuit 262 corresponds to the determination result of whether or not the IP packet is valid.

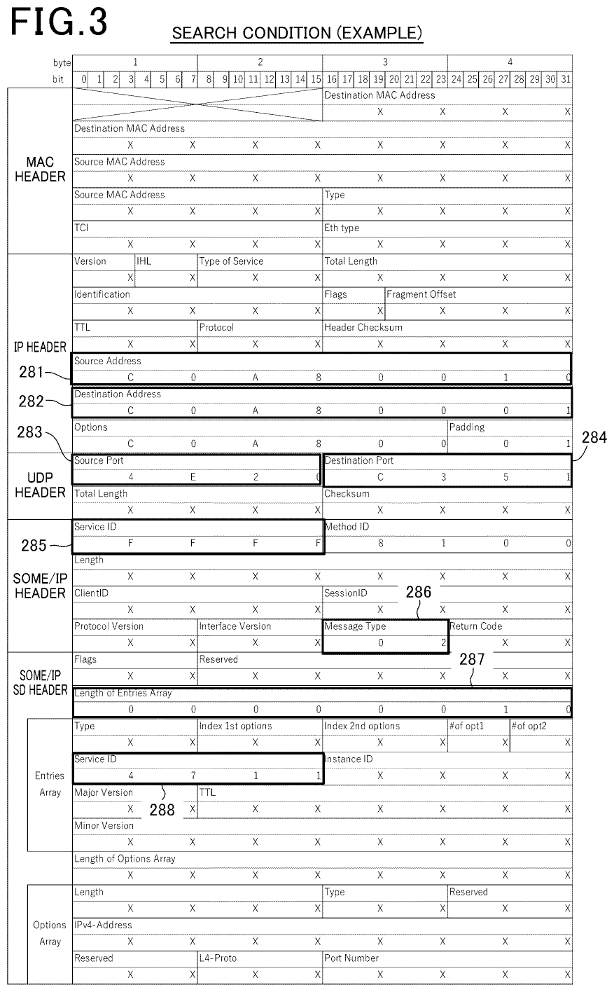

FIG. 3 is a diagram showing an example of a search condition for an Ethernet frame set in the transfer determination unit 26, and will be explained with SOME/IP-SD communication as an example. In this embodiment, the contents of each field shown below, including the value of the Length of Entries Array field, are specified in the search condition. Note that the reference numerals of the bit string portions shown below are respectively the reference numerals of the bit string portions shown in FIG. 3.
Bit string portion 281: SourceAddress of the IP header (the IP address of the source ECU)
Bit string portion 282: DestinationAddress of the IP header (the IP address of the destination ECU)
Bit string portion 283: SourcePort of the UDP header (the communication port number of the source ECU)
Bit string portion 284: DestinationPort of the UDP header (the communication port number of the destination ECU)
Bit string portion 285: ServiceID of the SOME/IP header (a fixed value of 0×FFFF indicating the SOME/IP-SD communication)
Bit string portion 286: MessageType of the SOME/IP header (a fixed value of 0×02)
Bit string portion 287: the Length of Entries Array of the SOME/IP-SD header (a fixed value of 0×10)
Bit string portion 288: ServiceID in the Entries Array of the SOME/IP-SD header (the service ID of the service exchanged between the ECUs)

Of the regular ECU 6 and ECU 7, one can become the source and its IP address is set in the bit string portion 281, and the other becomes the destination and its IP address is set in the bit string portion 282. Of the regular ECU 6 and ECU 7, one can become the source and its communication port number is set in the bit string portion 283, and the other becomes the destination and its communication port number is set in the bit string portion 284. In addition, a fixed value of 0×FFFF that indicates SOME/IP-SD communication, is set in the bit string portion 285. A fixed value of 0×02 in the SOME/IP-ID message is set in the bit string portion 286. In addition, a fixed value of 0×10 that defines the length of the Entries Array, which is a variable length portion, is set in the bit string portion 287. A service ID, which indicates the regular service exchanged between the ECU 6 and the ECU 7, is set in the bit string portion 288.

Note that in fields other than the above fields each defined by a search condition, for example, a value of “X (Don't Care)” is set.

In this embodiment, the transfer determination unit 26 is set with a plurality of search conditions as a whitelist indicating regular conditions, similar to the search conditions shown in FIG. 3.

As described above, in this embodiment, since the Length of Entries Array (fixed value of 0×10) of the SOME/IP-SD header is always checked, the search conditions need to contain at least the first 74 bytes of the Ethernet frame. Therefore, the number of TCAM entries to be used in the search conditions is two or three (i.e., a search condition of 96 bytes or 144 bytes overall).

The bit string portions 281, 282, 283, 284, 285, 286, 287, and/or 288 corresponding to the specified fields can also contain the value “X”. For example, when the service ID to be set in the bit string portion 288 has a characteristic common portion in binary or hexadecimal notation and there is no need to check the portion other than the common portion, the bit value of the bit position corresponding to the portion other than the common portion may be set to “X”. This can reduce the number of search conditions, and reduce the processing load on the transfer determination unit 26, improving the processing speed.

Note that the search condition shown in FIG. 3 is only an example, and the search conditions set in the transfer determination unit 26 may be set according to the design of the ECUs 6 and 7. For example, the search conditions may contain the value of the Type field in the Entries Array of the SOME/IP-SD header. In this case, in the SOME/IP communication standard, the interpretation of the message type indicated by the Type field may differ depending on the value of the TTL field in the Entries Array (zero or non-zero). For this reason, the specification of the value of the TTL field may be contained in the search conditions in addition to the specification of the value of the Type field. For example, a value of 0×01 in the Type field indicates that the SOME/IP message is an OfferService message if the value of the TTL field is not zero, and indicates that it is a StopOfferService message if the value of the TTL field is zero.

As described above, when the ECU 6 or the ECU 7 executes SOME/IP-SD communication that conforms to the SOME/IP communication standard, the number of service entries contained in the Entries Array can be any number. In other words, the number of service entries contained in the Entries Array is optional, and the Entries Array is variable length information.

Since an IP packet can contain any number of service entries, the size of the IP packet may exceed the maximum of three entries (maximum 144 bytes) that the TCAM used in the routing device 5 can process, or it is necessary to set up as many TCAM entries as there are permutations of the numbers of service entries for the condition storage memory 261, so that the number of the TCAM entries may exceed the upper limit of the number of entries (maximum 512).

In the future, it is expected that the number of services will increase, such as by adding functions of ECUs involved in SOME/IP-SD communication, such as the ECU 7. In addition, it is expected that ECUs with many functions other than the ECU shown in FIG. 1 as the ECU 7 will be mounted on the vehicle 2, and the number of services using SOME/IP-SD communication will also increase.

As such, for the increase in services using SOME/IP-SD communication, there are limitations to appropriately determining whether or not an IP packet is a regular packet by TCAM processing alone, which has led the present inventors to proposing the present disclosure.

Furthermore, if a TCAM with a sufficiently large capacity of the storage area is used to address the issue of increasing IP packet size, there is a concern that the cost of the routing device 5 will increase. The present inventors have been led to proposing the vehicle control system 1 of the present disclosure in order to increase the degree of freedom in employing TCAMs. In other words, the present disclosure has achieved a configuration that sets the number of service entries contained in IP packets to be processed by the TCAM to a predetermined number or less, thereby enabling increase in the degree of freedom in employing the TCAM and enabling the transfer of IP packets with more than the predetermined number of service entries.

In the vehicle control system 1 of this embodiment, the transfer determination unit 26 sets the number of service entries to be contained in the SOME/IP-SD header of SOME/IP communication to a predetermined number or less. Specifically, for each Ethernet frame received via the communication unit 20 and temporarily stored in the frame buffer 22, the transfer determination unit 26 determines whether or not a predetermined value set in advance is set in the Length of Entries Array field of the SOME/IP-SD header, which serves as the bit length field.

In other words, the transfer determination unit 26 includes a check of the value of the Length of Entries Array field of the SOME/IP-SD header in the search conditions set in the TCAM entry. In the SOME/IP communication standard, the Length of Entries Array field shall indicate the length of the bit string in which the service entry is stored, and the length is 0×10 (i.e., 16 bytes) when there is one service entry. The transfer determination unit 26 permits transfer from the ECU 7 to the ECU 6 on the condition that a predetermined value (0×10) is set in the Length of Entries Array field.

As a result, the transfer determination unit 26 only needs to determine the legitimacy of the IP packet within the range of 106 bytes from the start of the Ethernet frame to the end of the first SOME/IP-SD header (the first 106 bytes). As described above, in this embodiment, the TCAM entry of the TCAM that constitutes the transfer determination unit 26 is 48 bytes. Therefore, for the first 106 bytes, a search condition can be set using a maximum of three entries (48 bytes/entry×3 entries=144 bytes).

In other words, if a maximum of three TCAM entries (144 bytes) are used corresponding to the position range in the first 106 bytes of one or a plurality of fields to be set in the search conditions, the legitimacy of the Ethernet frame (and therefore the legitimacy of the IP packets contained in that Ethernet) can be determined.

In this way, the transfer determination unit 26 permits the transfer of the received communication packet on the condition that the predetermined value is set in the bit length field that defines the bit length of the variable length portion of the received communication packet. If the predetermined value set in advance is not set in the bit length field that defines the bit length of the variable length portion of the received communication packet, the processing device 110 performs processing, which will be described below. This fixes the bit length of the variable length portion of the communication packet, so there is no risk of exceeding the capacity of the TCAM storage area, allowing the communication packet to be processed reliably. In addition, this makes it easier to detect the unauthorized communication packets, shortening the time required for processing of detecting the unauthorized communication packets. This can provide the vehicle control system 1 with easier detection of unauthorized communication and defense against it while maintaining high responsiveness of vehicle control.

Furthermore, in this embodiment, in addition to the value of the Length of Entries Array field, the transfer determination unit 26 checks whether or not the contents of predetermined fields of the IP packet are valid in which the contents include: the source address, the source port number, the destination address, the destination port number, and the Service ID field and the Message Type field of the SOME/IP header. This additionally makes it possible to confirm that the communication relates to a correct service from a correct party, making it possible to more reliably detect unauthorized communication from an attacker.

If the contents of these fields are valid, the transfer determination unit 26 permits the gate unit 25 to transfer the communication of the Ethernet frame containing that IP packet. Contrarily, if the contents are invalid, the transfer determination unit 26 prohibits the gate unit 25 from transferring the communication of the Ethernet frame containing that IP packet. The gate unit 25 outputs, to the switch unit 23, the Ethernet frame for which the transfer determination unit 26 has permitted communication transfer, and discards the Ethernet frame for which the transfer determination unit 26 has prohibited communication transfer.

This determines whether or not the IP packet is valid, that is, whether it is a packet carrying a SOME/IP-SD communication message related to a regular service from a regular ECU, and prevents communication of unauthorized IP packets (i.e., unauthorized communication).

The transfer determination unit 26 can be configured to determine whether or not to transfer an IP packet received from the ECU 7 to the processing device 110, in addition to determining whether or not to transfer the IP packet from the ECU 7 to the ECU 6. Specifically, if a predetermined value set in advance is not set in the bit length field that defines the bit length of the variable length portion of the communication packet received from the ECU 7, the transfer determination unit 26 determines to transfer this packet to the processing device 110 to have the processing device 110 execute processing.

As an example, a configuration will be described that has a condition on which the transfer determination unit 26 transfers a frame from the ECU 7 to the ECU 6, and a condition on which the transfer determination unit 26 transfers a frame from the ECU 7 to the processing device 110. In this configuration, for example, the determination conditions (search conditions) set in the transfer determination unit 26 are numbered to be managed as shown below. The transfer determination unit 26 executes match determinations on the determination conditions in order from the smallest number of determination condition, and determines whether or not the frame satisfies the determination condition.
(Condition 1): IP, PORT, ServiceID, LengthEntriesArray
(Condition 2): IP, PORT, ServiceID

In this example, the transfer determination unit 26 performs a match determination on condition 1 for the received Ethernet frame, and performs a match determination on condition 2 for a frame that do not satisfies condition 1. For example, if a frame is received that has a Length of Entries Array field with a value of 0×10, the transfer determination unit 26 determines that the condition 1 is satisfied. In this case, the transfer determination unit 26 determines to transfer the frame to the ECU 6 in accordance with the determination based on the condition 1. Contrarily, if a frame is received that has a Length of Entries Array field with a value other than 0×10, the transfer determination unit 26 determines that this frame does not satisfy the condition 1, and performs the match determination on the condition 2. If the frame satisfies condition 2, the transfer determination unit 26 determines that the frame is to be transferred to the processing device 110.

This example can also be said to be a configuration such that the transfer determination unit 26 has condition 1 for determining to transfer an Ethernet frame received from the ECU 7 to the ECU 6, and condition 2 for determining to transfer an Ethernet frame received from the ECU 7 to the processing device 110.

Furthermore, when an Ethernet frame received from ECU 6 is transferred to ECU 7, the transfer determination unit 26 may have a plurality of determination conditions that are numbered and managed as described above, to make a determination by applying these plurality of determination conditions in order.

The function of the transfer determination unit 26 to determine an IP packet based on the value of the Length of Entries Array field may be configured to be executed in only one direction of directions of the Ethernet frame transfer between the ECU 6 and the ECU 7. Since the ECU 6 included in the first control device group 3 does not include a control device that communicates with the outside of the vehicle 2, there is little concern about unauthorized access to the vehicle control system 1. For this reason, the transfer determination unit 26 can be configured to execute the determination based on the value of the Length of Entries Array field only for Ethernet frames transferred from the ECU 7 to the ECU 6, and not to apply the determination onto Ethernet frames transferred from the ECU 6 to the ECU 7. In this case, communication from the first communication network 9 to the second communication network 10 can be transferred at higher speed.

### [4. Communication Management Device]

The communication management device 8 is, for example, a computer including a processor such as a CPU. The communication management device 8 sets the search conditions of the transfer determination unit 26 by executing a program with the processor. The communication management device 8 includes a non-volatile storage device such as a ROM, and stores the search conditions to be set in the transfer determination unit 26.

The communication management device 8 may include a communication device including a transmitter and a receiver that communicates with a server device or the like outside the vehicle 2. The communication management device 8 receives a list of search conditions to be set in the transfer determination unit 26 from, for example, a server device, and stores the list as a search condition list. The communication management device 8 transmits the search condition list to the routing device 5 in response to a request from the routing device 5 (for example, the management unit 27). As described above, the management unit 27 of the routing device 5 transmits the request to the communication management device 8, receives the transmitted search condition list, and sets it in the transfer determination unit 26, for example, when the routing device 5 is started. This allows the transfer determination unit 26 to appropriately set search conditions for determining whether or not an IP packet is a valid IP packet.

### [5. Processing Device]

As shown in FIG. 1, the processing device 110 includes a frame processing unit 111. The processing device 110 is a computer including a processor such as a CPU, and a storage device that stores programs to be executed by the processor and data processed by the processor. The frame processing unit 111 is a functional unit that is implemented by the processor of the processing device 110 executing a program.

The processing device 110 has a function of hooking Ethernet frames received by the routing device 5 from the ECU 6 or the ECU 7, in other words, a function of receiving Ethernet frames that the routing device 5 transfers to the processing device 110. FIG. 1 shows a configuration such that the processing device 110 acquires Ethernet frames to be sent from the frame buffer 22 to the gate unit 25. However, the connection aspect between the processing device 110 and the routing device 5 in FIG. 1 is an example. The configuration only needs to be such that: of the Ethernet frames received by the communication unit 20, frames that are in SOME/IP-SD communication and have more than one service entry are sent to the processing device 110; and the frames processed by the processing device 110 are sent again to the communication unit 20.

The processing device 110 processes the transferred Ethernet frames with the frame processing unit 111. The frame processing unit 111 detects Ethernet frames with more than one service entry. For example, the frame processing unit 111 refers to the value of the Length of Entries Array in the SOME/IP-SD header of the Ethernet frame, and determines that the Ethernet frame, which has a value greater than a predetermined value (0×10) when the number of service entries is one, is to be processed. Here, the frame processing unit 111 may be configured to detect that the transferred Ethernet frame is an Ethernet frame for SOME/IP-SD communication and has more than one service entry.

The frame processing unit 111 generates a plurality of Ethernet frames based on the Ethernet frame determined to be processed. In detail, the frame processing unit 111 generates a plurality of Ethernet frames, each containing one service entry, from the Ethernet frame containing a plurality of service entries. The service entries contained in the Ethernet frames generated by the frame processing unit 111 are the service entries acquired from the Ethernet frame to be processed. In other words, the frame processing unit 111 converts the Ethernet frame containing the plurality of service entries into Ethernet frames each containing a single service entry that can be determined whether to be transferred by the routing device 5.

The frame processing unit 111 sends the processed Ethernet frames to the communication unit 20. The Ethernet frames sent by the frame processing unit 111 are received by the routing device 5 and stored in the frame buffer 22, just like a frame transmitted by the ECU 6 or the ECU 7 to the routing device 5. Since each of the Ethernet frames contains one service entry, it is transferred by the routing device 5 after going through the above-mentioned determination. The Ethernet frame with one service entry is not transferred to the frame processing unit 111, eliminating the concern that the processing of the same Ethernet frame will loop in the frame processing unit 111.

When the above-mentioned processing is performed, the number of service entries contained in the Ethernet frame is limited to one in the Ethernet frame that the routing device 5 transfers to the ECU 6 or the ECU 7. This makes it possible to transfer the communication at high speed. If there are a plurality of service entries and the above-mentioned processing is not performed, vehicle control will be impossible with that Ethernet frame. In this embodiment, an Ethernet frame containing a plurality of service entries is converted into Ethernet frames each containing a single service entry. This makes it possible to transfer an Ethernet frame containing a plurality of service entries without impairing high-speed processing of the routing device 5.

Furthermore, in the process of generating Ethernet frames, the frame processing unit 111 sets a value in each field of the MAC header. The Ethernet frame that the processing device 110 acquires from the routing device 5 can be in a form of IP packet that does not contain a MAC header, depending on the layer processed in the routing device 5. When the processing device 110 acquires a frame from a configuration in which the routing device 5 processes the network layer (IP layer), the MAC header is missing from the acquired frame. To handle these cases, the frame processing unit 111 acquires the IP packet of the Ethernet frame to be processed, and generates a plurality of IP packets from the plurality of service entries included in this IP packet. Then, the frame processing unit 111 creates a MAC header for the generated IP packet. In other words, the frame processing unit 111 sets a value in each of the fields of Destination MAC Address, Source MAC Address, TCI, Type, and Eth Type.

In setting the MAC addresses of the destination and source devices, the frame processing unit 111 refers to an ARP (Address Resolution Protocol) table 113. The ARP table 113 is information that the processing device 110 has in advance, and associates an IP address with the MAC address. The frame processing unit 111 acquires the MAC address from the ARP table 113 based on each of the IP addresses of the destination and source devices, and generates a MAC header. This ensures that the Ethernet frame can be transferred regardless of which layer of the routing device 5 the processing device 110 hooks the frame from.

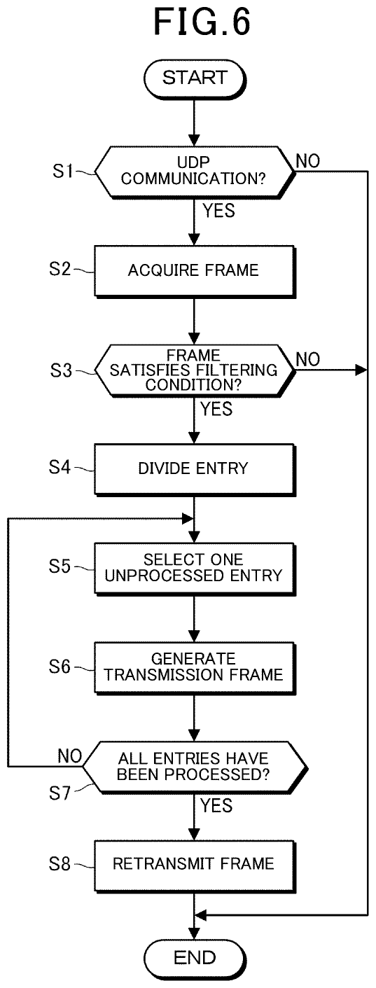

FIG. 6 is a flowchart showing the operation of the processing device 110. Steps S1 to S8 in FIG. 6 are executed by the frame processing unit 111.

The processing device 110 refers to an Ethernet frame that can be acquired from the routing device 5, and determines whether or not the Ethernet frame is a frame of UDP communication (step S1). In this embodiment, the Ethernet frame that the processing device 110 determines to be a target of the conversion processing is limited to UDP communication. When large-sized data such as video contents is transmitted through UDP communication, transmission and reception of Ethernet frames containing a plurality of service entries is likely to occur. This brings advantage in which targeting UDP communication allows the communication to be transferred more efficiently.

If the referenced Ethernet frame is not an Ethernet frame of UDP communication (step S1: NO), the processing device 110 ends this process and acquires the next communication. Contrarily, if the referenced Ethernet frame is a frame of UDP communication (step S1: YES), the processing device 110 acquires this frame and determines whether or not the acquired frame satisfies the filtering condition (step S3).

The filtering condition in step S3 is a condition that is predefined for the frame to be processed by the processing device 110. For example, the filtering condition is that the number of service entries contained in the frame exceeds one.

The filtering condition may also include that the acquired frame is a frame of SOME/IP-SD communication. The filtering condition may also include that the destination IP address (DestinationAddress) in the IP header is a multicast address. The filtering condition may also include that the source IP address (SourceAddress) in the IP header indicates a specific ECU. The filtering condition may also include that the destination port number (DestinationPort) in the UTP header is a specific port number. The specific ECU is, for example, an ECU that supports functions related to information processing, and an example is an ECU in an IVI system. The specific port number is, for example, an SD common port prepared for SD communication. These filtering conditions prevent unnecessary frames from undergoing frame conversion processing, enabling the processing device 110 to perform processing more efficiently.

If the acquired frame does not satisfy the filtering conditions (step S3: NO), the processing device 110 ends this processing and acquires the next communication.

Contrarily, if the acquired frame satisfies the filtering conditions (step S3: YES), the processing device 110 divides the entry of this frame (step S4). In detail, the processing device 110 sets the number of service entries by referring to the Length of Entries Array field. The processing device 110 acquires the EntriesArray fields contained in the Ethernet frame one by one, and temporarily stores each EntriesArray field individually. Here, the processing device 110 stores the correspondence between the value of the Index 1st Options field of each EntriesArray and the value of the Length field of the Options Array.

The processing device 110 selects one unprocessed service entry from the service entries obtained through the division in step S4 (step S5), and generates an Ethernet frame containing the selected service entry (step S6).

In step S6, the processing device 110 adds an OptionsArray field, etc., to the selected service entry in accordance with the correspondence between the value of the Index 1st Options field and the value of the Length field of the Options Array, thereby generating a SOME/IP-SD header containing one service entry. Furthermore, the processing device 110 adds the same IP header, UDP header, and SOME/IP header as in the original frame to the generated SOME/IP-SD header, generating an IP packet. Here, the processing device 110 changes the value of the Length of Entries Array field of the SOME/IP-SD header to a predetermined value (0×10) corresponding to one service entry. The processing device 110 refers to the ARP table 113 based on the source IP address of the IP header, and acquires the source MAC address. In addition, the processing device 110 sets the destination MAC address to the multicast address. The processing device 110 generates a MAC header containing the source MAC address acquired from the ARP table 113 and the set destination MAC address, and adds it to the IP packet, thereby generating an Ethernet frame. The Ethernet frame generated by the series of processes in step S6 has the same form as the Ethernet frame that the routing device 5 receives from the ECU 6 or the ECU 7.

The processing device 110 determines whether or not the processing in steps S5 to S6 has been completed for all service entries obtained through the division in step S4 (step S7). If there are any unprocessed entries (step S7: NO), the processing device 110 returns to step S5 and processes the unprocessed entries.

If the process of generating Ethernet frames for all service entries is completed (step S7: YES), the processing device 110 retransmits the Ethernet frame generated in step S6 (step S8). Retransmission is a process in which the processing device 110 sends an Ethernet frame to the communication unit 20 by disguising the Ethernet frame as a frame transmitted from the ECU 6 or the ECU 7. In step S8, the processing device 110 transmits all of the plurality of frames generated based on one Ethernet frame together.

The processing device 110 may execute the process of FIG. 6 only for Ethernet frames to be transmitted from the ECU 7 to the ECU 6. In other words, the processing device does not transfer Ethernet frames transmitted from the ECU 6 to the ECU 7, to the processing device 110. For example, there may be a configuration such that, in the vehicle control system 1, the vehicle control unit 100 is included in the ECU 7. In this case, the routing device 5 determines whether or not it is possible to transfer the Ethernet frame to be transmitted from the ECU 7 to the ECU 6 based on search conditions including that the number of service entries is equal to or less than a predetermined number. The processing device 110 then hooks the Ethernet frame transmitted from the ECU 7 to the ECU 6, and processes the Ethernet frame that is in SOME/IP-SD communication and has a number of service entries exceeding the various constants. In this configuration, the routing device 5 can be configured to not to limit the number of service entries and to also transfer frames containing a plurality of service entries, for SOME/IP-SD communication transmitted from the ECU 6 to the ECU 7. In this case, reliable processing of detecting the unauthorized communication packets can be executed for SOME/IP-SD communication from the ECU 7, which includes a control device that communicates with the outside of the vehicle 2, to the ECU 6. Furthermore, communication packets transmitted from the ECU 6, which does not include a control device that communicates with the outside of the vehicle 2, to the ECU 7 can be transferred without limiting the number of service entries, thereby making the SOME/IP-SD communication further more efficient.

### [6. Other Embodiments]

In the above embodiment, the processing device 110 may acquire all of the communication, which is processed by the routing device 5, in step S2 (FIG. 6), not limited to UDP communication. In other words, the processing in step S1 may be omitted.

In the above embodiment, the condition for the transfer determination unit 26 to permit transfer from the ECU 7 to the ECU 6 is exemplified as a condition that a predetermined value (0×10) is set in the Length of Entries Array field. In addition, an example is described in which the transfer determination unit 26 permits transfer on the condition that a predetermined value is set in the bit length field that defines the bit length of the variable length portion of the received communication packet. These conditions are merely examples, and the conditions for the transfer determination unit 26 to permit transfer may be other conditions. In addition, the transfer determination unit 26 may determine whether to permit transfer by combining a plurality of conditions including other conditions.

The function of the gate unit 25 may be included in the switch unit 23 or the frame buffer 22. In these cases, the switch unit 23 or the frame buffer 22 can transfer or discard the Ethernet frame containing the IP packet according to the instruction from the transfer determination unit 26.

The route determination unit 24 can be configured of a TCAM according to the conventional technique. The transfer determination unit 26 and the route determination unit 24 may be configured of one TCAM.

The transfer determination unit 26 is configured of a TCAM (Ternary Content Addressable Memory) in the above-mentioned embodiment, but it may be configured of a microprocessor or the like that performs similar processing. However, in this case, the processing speed of the transfer determination unit 26 may be slower than when a TCAM is used.

Note that the present invention is not limited to the configuration of the above-mentioned embodiment, and can be embodied in various aspects without departing from the gist of the present invention.

### [7. Configurations Supported by the Above-mentioned Embodiments]

The above-mentioned embodiments support the following configurations.

(Configuration 1) A vehicle control system mounted on a vehicle, including: a transfer unit that is connected to a first control device group connected to a first communication network and a second control device group connected to a second communication network different from the first communication network, and that transfers at least one communication packet including at least one message between communication networks including the first communication network and the second communication network; and a processing unit that processes a communication packet containing more than a predetermined number of messages, the communication packet being included in at least one communication packet received by the transfer unit from the communication networks, wherein the transfer unit transfers a communication packet containing the predetermined number or less of the message or messages, and the processing unit performs processing to enable a communication packet, containing more than the predetermined number of the messages, to be transferred by the transfer unit.

According to the vehicle control system of Configuration 1, communication packets are transferred with a limit on the number of messages contained in each communication packet, thereby making it easier to detect unauthorized communication packets to be transferred as well as shortening the time required for processing of detecting the unauthorized communication packets. Furthermore, enabling communication packets exceeding the limit on the number of messages to be transferred by the processing unit allows necessary communication packets to be transferred without being discarded. This can provide the vehicle control system of Configuration 1 with easier detection of unauthorized communication and defense against it while maintaining high responsiveness of vehicle control.

(Configuration 2) The vehicle control system according to Configuration 1, wherein the processing unit generates a plurality of communication packets including the predetermined number or less of message or messages, based on a communication packet containing more than the predetermined number of messages, and the processing unit causes the transfer unit to transfer generated communication packets.

The vehicle control system of Configuration 2 causes a communication packet that exceeds the limit on the number of messages to be communication packets that comply with the limit, and thereby the necessary communication packet is transferred without being discarded, making it possible to achieve detection of unauthorized communication and defense against it, and responsiveness of vehicle control at the same time.

(Configuration 3) The vehicle control system according to Configuration 2, wherein the processing unit processes a communication packet that conform to a UDP communication standard, the communication packet being included in at least one communication packet to be received by the transfer unit.

The vehicle control system of Configuration 3 makes it possible to achieve detection of unauthorized communication and defense against it, and responsiveness of vehicle control at the same time, for communication packets of UDP communication that tends to be used to transfer large-sized data. In addition, limiting the type of communication packets to be processed makes it possible to improve the efficiency of processing.

(Configuration 4) The vehicle control system according to Configuration 3, wherein a communication packet to be received by the transfer unit includes a message count field that indicates a number of message or messages, and the processing unit acquires messages from a communication packet that contains more than the predetermined number of messages, and the processing unit generates communication packets including a plurality of acquired messages, each acquired message corresponding to a generated communication packet.

The vehicle control system of Configuration 4 does not miss messages contained in a communication packet with the number of messages exceeding the limit, and makes communication packets comply with the limit, thereby making it possible to achieve detection of unauthorized communication and defense against it, and responsiveness of vehicle control, at the same time.

(Configuration 5) The vehicle control system according to Configuration 3, wherein a communication packet to be received by the transfer unit contains a MAC header and an IP header, the transfer unit performs processing to transfer a communication packet based on a source address in an IP header, and the processing unit acquires a communication packet received by the transfer unit from the communication networks, acquires a MAC address corresponding to a source address in an IP header of an acquired communication packet by referring to a predetermined table, and generates a communication packet to which a MAC header containing the acquired MAC address is added.

The vehicle control system of Configuration 5 allows the processing unit to acquire and process communication packets from the layer in which the transfer unit processes IP packets excluding MAC headers. As a result, communication packets can be processed without increasing the load on the transfer unit, thereby achieving further higher efficiency.

(Configuration 6) The vehicle control system according to Configuration 4, wherein the processing unit performs processing to change a message count field of each of generated communication packets to the predetermined number or less, and the processing unit then causes the transfer unit to transfer the generated communication packets, the generated communication packets being generated from a communication packet containing more than the predetermined number of messages.

The vehicle control system of Configuration 6 allows the communication packet processed by the processing unit to be reliably transferred by the transfer unit.

(Configuration 7) The vehicle control system according to Configuration 6, wherein the processing unit completes processing for a message count field of each of a plurality of communication packets generated from a communication packet containing more than the predetermined number of messages, and the processing unit then causes the transfer unit to transfer the plurality of processed communication packets.

The vehicle control system of Configuration 7 allows the message contained in a communication packet having a number of messages exceeding the limit to be processed by the transfer unit without making a large time difference.

(Configuration 8) The vehicle control system according to any one of Configurations 1 to 7, wherein the transfer unit determines whether or not to permit transfer of each of at least one communication packet that is included in at least one communication packet received from the communication networks and that contains the predetermined number or less of message or messages, and the transfer unit then transfers the communication packet permitted to be transferred.

The vehicle control system of Configuration 8 detects the unauthorized communication packets to be transferred, thereby making it possible to achieve detection of unauthorized communication and defense against it.

### Reference Signs List

1 . . . vehicle control system, 2 . . . vehicle, 3 . . . first control device group, 4 . . . second control device group, 5 . . . routing device (transfer unit), 6, 7 . . . ECU, 6a . . . drive ECU, 6b . . . steering ECU, 6c . . . battery ECU, 6d . . . ADAS-ECU, 7a . . . TCU, 7b . . . IVI-ECU, 7c. . . . DMC-ECU, 8 . . . communication management device, 9 . . . first communication network, 10 . . . second communication network, 20 . . . communication unit, 21 . . . input/output port, 22 . . . frame buffer, 23 . . . switch unit, 24 . . . route determination unit, 25 . . . gate unit, 26 . . . transfer determination unit, 261 . . . condition storage memory, 262 . . . search circuit, 27 . . . management unit, 100 . . . vehicle control unit, 110 . . . processing device (processing unit), 111 . . . frame processing unit, 113. . . . ARP table, 281, 282, 283, 284, 285, 286 . . . bit string portion.

1. A vehicle control system mounted on a vehicle, comprising:
a transfer unit that is connected to a first control device group connected to a first communication network and a second control device group connected to a second communication network different from the first communication network, and that transfers at least one communication packet including at least one message between communication networks including the first communication network and the second communication network; and
a processing unit that processes a communication packet containing more than a predetermined number of messages, the communication packet being included in at least one communication packet received by the transfer unit from the communication networks, wherein
the transfer unit transfers a communication packet containing the predetermined number or less of the message or messages, and
the processing unit performs processing to enable a communication packet, containing more than the predetermined number of the messages, to be transferred by the transfer unit.

2. The vehicle control system according to claim 1, wherein the processing unit generates a plurality of communication packets including the predetermined number or less of message or messages, based on a communication packet containing more than the predetermined number of messages, and the processing unit causes the transfer unit to transfer generated communication packets.

3. The vehicle control system according to claim 2, wherein the processing unit processes a communication packet that conform to a User Datagram Protocol (UDP) communication standard, the communication packet being included in at least one communication packet to be received by the transfer unit.

4. The vehicle control system according to claim 3, wherein
a communication packet to be received by the transfer unit includes a message count field that indicates a number of message or messages, and
the processing unit acquires messages from a communication packet that contains more than the predetermined number of messages, and the processing unit generates communication packets including a plurality of acquired messages, each acquired message corresponding to a generated communication packet.

5. The vehicle control system according to claim 3, wherein
a communication packet to be received by the transfer unit contains a MAC (Media Access Control) header and an IP (Internet Protocol) header,
the transfer unit performs processing to transfer a communication packet based on a source address in an IP header, and
the processing unit
acquires a communication packet received by the transfer unit from the communication networks,
acquires a MAC address corresponding to a source address in an IP header of the acquired communication packet by referring to a predetermined table, and
generates a communication packet to which a MAC header containing the acquired MAC address is added.

6. The vehicle control system according to claim 4, wherein the processing unit performs processing to change a message count field of each of the generated communication packets to the predetermined number or less, and the processing unit then causes the transfer unit to transfer the generated communication packets, the generated communication packets being generated from a communication packet containing more than the predetermined number of messages.

7. The vehicle control system according to claim 6, wherein the processing unit completes processing for a message count field of each of a plurality of communication packets generated from a communication packet containing more than the predetermined number of messages, and the processing unit then causes the transfer unit to transfer the plurality of processed communication packets.

8. The vehicle control system according to claim 1, wherein the transfer unit determines whether or not to permit transfer of each of at least one communication packet that is included in at least one communication packet received from the communication networks and that contains the predetermined number or less of message or messages, and the transfer unit then transfers the communication packet permitted to be transferred.
